(19) United States
(12) Patent Application Publication
(10) Pub. No.: US 2025/0265133 A1
(43) Pub. Date: Aug. 21, 2025

(54) EDGE-INTERFACE

(71) Applicant: University of South Carolina, Columbia, SC (US)

(72) Inventor: Braden Guliano, Lexington, SC (US)

(73) Assignee: University of South Carolina, Columbia, SC (US)

(21) Appl. No.: 18/987,840

(22) Filed: Dec. 19, 2024

Related U.S. Application Data
(60) Provisional application No. 63/555,146, filed on Feb. 19, 2024.

(51) Int. Cl. G06F 9/54; G06F 9/455

(52) U.S. Cl. CPC G06F 9/547; G06F 9/45529

(57) ABSTRACT

Described herein are systems and methods to reduce the difficulty of setting up and managing a web interface for an Industrial Edge Device app and to enable bi-directional communication between Python® and a web interface.

### CROSS-REFERENCE TO RELATED APPLICATION

The present application claims priority to and the benefit of U.S. Provisional Patent Application No. 63/555,146 filed Feb. 19, 2024, the contents of which is hereby incorporated in its entirety.

### TECHNICAL FIELD

The subject matter disclosed herein is generally directed systems and methods to reduce the difficulty of setting up and managing a web interface for an Industrial Edge Device app and to enable bi-directional communication between Python® and a web interface.

### BACKGROUND

Typically, Python® can only send data during the initialization of a webpage or if the web interface initiates a data stream first.

Accordingly, it is an object of the present disclosure to solve two main problems: the difficulty of setting up and managing a web interface for an Industrial Edge Device app and, more abstractly, it enables bi-directional communication between Python® and a web interface.

Citation or identification of any document in this application is not an admission that such a document is available as prior art to the present disclosure.

### SUMMARY

The above objectives are accomplished according to the present disclosure by providing in one instance a framework for attaching web interfaces to existing applications. The framework may include at least one web interface, at least one existing application, at least one framework containing at least one source code for managing the at least one web interface, wherein the at least one source code is structured to work with multiple web interfaces, and the at least one framework configured wherein at least one data transmitted bidirectionally between at least one Python® script and at least one webpage to enable at least one webpage element to interact with at least one portion of the at least one Python® script. Further, no rewriting of at least one logic may be required for the at least one web interface to incorporate the framework with the at least one existing application. Additionally, no manual integration of the at least one framework into the existing application may be required. Again, transmission of the at least one data transmitted bidirectionally between at least one Python® script and at least one webpage may run continuously via sending at least one series of sequential GET and POST requests. Still yet, the sequential GET and POST requests may each have their own topic, identifier, flag, and payload to create a bi-directional data flow between the at least one framework and the at least one webpage. Moreover, the at least one Python® script cannot only send data during an initialization of the at least one webpage or when the at least one web interface initiates a data stream first but the at least one Python® script may send data upon request at any time by the at least one webpage to create a command loop.

In a further embodiment, the current disclosure may provide a method for creating a framework for attaching web interfaces to existing applications. The method may include at least one webpage initiating at least one POST request to at least one webpage, at least one interface defining at least one interface Postman object that manages transmission and reception of the at least one POST request and records a session id contained within the at least one POST request, the at least one interface Postman object using the session id to select at least one session object from at least one session store, wherein the at least one session store corresponds to the at least one session id, and the at least one interface Postman object may respond with at least one JSON representation of at least one command object in a queue of the session object selected. Further, the at least one JSON representation may contain a task for the at least one webpage to complete as at least one payload. Still further, the at least one payload may be executed in the at least one webpage's Javascript code. Still yet again, the at least one webpage's Javascript code may send a follow-up POST request, wherein the follow-up POST request has at least one identifier matching the at least one POST request and contains data representing at least one output of at least one completed task. Further, the process stated above may be repeated to form at least one command loop. In addition, the method may form a thread-safe queuing system wherein at least one packet is sent and received at any time from either the at least one interface or from at least one Python® script. Again still, multiple open sessions of the at least interface are open, the at least one interface may dispatch a correct command to a correct session via recording a current thread identifier inside the session store and matching the current thread identifier with the session from which a most recent POST request originated. Further yet, the method may include that a rate at which the at least one packet is sent or received may be modifiable via an update-interval variable. Still yet again, the at least one web interface may operate asynchronously in a background thread while public methods are synchronous, allowing the at least one interface to run in a foreground without interruptions.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an Edge-Interface Diagram of the current disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the systems or methods described herein can be presented as a combination kit. As used herein, the terms “combination kit” or “kit of parts” refers to the compounds, compositions, formulations, and any additional components that are used to package, sell, market, deliver, and/or provide the combination of elements or a single element of the methods or systems, contained therein. Such additional components include, but are not limited to, packaging, storage material, and the like. When one or more of the compounds, compositions, formulations, and any additional components described herein or a combination thereof (e.g., agent(s)) contained in the kit are provided simultaneously, the combination kit can contain the method or systems in a single embodiment or multiple embodiments. When the compounds, compositions, formulations, particles, and any additional components herein or a combination thereof and/or kit components are not provided simultaneously, the combination kit can contain each method or system or other component in separate embodiments. The separate kit components can be contained in a single package or in separate packages within the kit.

In some embodiments, the combination kit also includes instructions printed on or otherwise contained in a tangible medium of expression. The instructions can provide information regarding the content of the compounds and/or systems or methods, safety information regarding the content of the compounds and formulations, information regarding viable applications, indications for use, and/or recommended practices for the systems, methods, or components thereof contained therein. In some embodiments, the instructions can provide directions and protocols for administering the systems or methods. In some embodiments, the instructions can provide one or more embodiments of the methods or systems such as any of the methods or systems described in greater detail elsewhere herein.

This innovation increases productivity, boosts efficiency, and simplifies a currently complex process. By providing developers with a framework to easily build and attach web interfaces to their existing applications, greater efficiency is achieved since manually attempting to integrate the convoluted process of bi-directional communication into an application can disrupt its natural logic flow. Without edge-interface, developers would also be forced to rewrite the logic that runs the web interface for each new project, since every program is structured differently. With the current innovation, however, the code to manage the web interface is generalized so that it may work with any preexisting project, thus increasing productivity.

This module streamlines the development and management of web interfaces for an Industrial Edge Device application. Data is sent bidirectionally between a Python® script and a webpage, enabling elements on the page to interact with portions of code in Python®. This loop runs continuously by sending a series of sequential GET and POST requests, each with its own topic, identifier, flags, and payload to create a bi-directional data flow.

This innovation solves two main problems: the difficulty of setting up and managing a web interface for an Industrial Edge Device app and, more abstractly, it enables bi-directional communication between Python® and a web interface. Typically, Python® can only send data during the initialization of a webpage or if the web interface initiates a data stream first. With this innovation, data can be sent both ways at any time, as soon as it is requested, called the Command Loop. Yet even a setup that solely implements the Command Loop would still be incompatible with an Edge Device application. This innovation, however, is designed in a way that still maintains compatibility with the way web interfaces are required to be structured on the Edge Device.

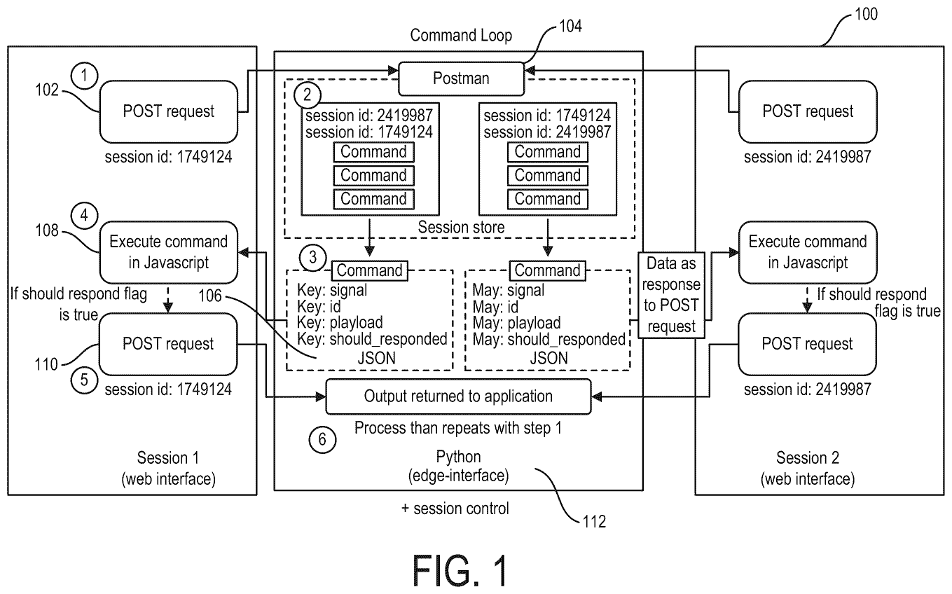

With respect to FIG. 1, the webpage first initiates a POST request to the current URL. Edge-interface's Postman object (which manages the transmission and reception of POST requests) will be notified of the incoming request and record the “session id” contained within the request. Using this “session id”, the Postman will select the Session object from its Session Store that matches this identifier. Finally, the Postman will respond with a JSON representation of the latest Command object in the queue of the Session object it selected. This JSON response contains a task for the webpage to complete as its payload, which is then executed in the webpage's Javascript. If necessary, the Javascript code will then send a follow-up POST request-with an identifier matching the original request-containing data that represents the output of the completed

task. This process is then repeated, hence the name Command Loop. Through this thread-safe queuing system, packets can be sent and received at any time from either the interface or Python®. In the case of multiple open sessions of the same web interface, as demonstrated in FIG. 1, edge-interface will appropriately dispatch the correct Command to the correct Session. This is accomplished by recording the current thread identifier inside the Session Store and matching it with the Session that sent the most recent POST request. The rate at which these packets are sent/received is modifiable via an update-interval variable. By design, edgeinterface operates asynchronously in a background thread while its public methods are synchronous, allowing the main part of an Industrial Edge app to run in the foreground without any undesired interruptions

This innovation would assist developers working in smart manufacturing plants or labs to quickly and efficiently display data their app collects or creates. With edge computing gaining popularity in the manufacturing sector, new technology such as the Siemens Industrial Edge Device will be adopted into various manufacturing facilities expanding the prospective market size of such an invention.

FIG. 1 shows one instance 100 of the current disclosure. At step 102, a POST request is issued from Session 1 to the Python® instance running an implementation of edge-interface. This request is a standard HTML POST request with a Content-Type header that contains “application/json”. The data contained in this request contains Session 1's session id. At step 104, the Postman analyzes the data received by the POST request and selects the appropriate queue to pull a Command from. The Session Store contains a mapping of sessions to their session id. At step 106, the extracted Command is encoded in JSON format, as this will be the body of the POST response to send back to Session 1. At step 108, Session 1 receives the JSON-encoded Command, parses it, and executes the task contained inside the “payload” JSON key. At step 110, if the “should respond” key/flag is true, a follow-up POST request is sent from Session 1 to the Python® instance. This request contains data generated from executing the task. At step 112, the data contained in the POST request is sent to the application running edge-interface. This procedure is repeated indefinitely until edge-interface is terminated. Session 2 operates the exact same way, but the Postman can sort and filter which data needs to go to which Session.

This module streamlines the development and management of web interfaces for an Industrial Edge Device application. Data gathered or calculated in an app using edge-interface can be easily and immediately displayed on a web interface with very few lines of code, eliminating the complexity this task would require otherwise.

Information can also easily be sent the other way; for instance, by running a certain portion of code in an app when a user presses a button on the web interface. This module works in the background to allow the main part of an app to run in the foreground without any interruption.

Further embodiments are illustrated in the following Examples which are given for illustrative purposes only and are not intended to limit the scope of the disclosure.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for.
Module edge_interface
Functions
def debug_print(*args, **kwargs)
For debugging ONLY; this just is a thread-safe print function
Classes
class Command (topic: str, payload: Any)
A container to streamline sending organized data to the web app's javascript
Attributes
topic: str
A category of data being sent, its purpose is similar to a MQTT topic
payload: Any
The raw data to be sent for processing
Class variables
var payload: Any
var topic: str
Static methods
def javascript(js: str)
A class method to quickly create a Javascript command
Parameters
js: str
The javascript to execute
def set_session_id(session_id: int)
A class method to quickly create a set_session_id command
Parameters
session_id: int
The session id to give the receiving page
def update_interval(interval: int)
A class method to quickly create an update interval command
Parameters
interval: int
How often the page should check for a new command (in millis)
class CommandLoopMessage (input_json: Dict[str, Any])
A simple container that converts the JSON data received from a command loop POST request to an
object using dot notation
Attributes
topic: str
A category of data being sent, its purpose is similar to a MQTT topic
payload: Any
The raw data to be sent for processing
id: int
The ID number for this particular message, used for matching an CommandLoopMessage to the
correct CommandLoopResponse
session_id: int
The ID number for the particular session this message came from, used for matching a
CommandLoopMessage to
class CommandLoopResponse (command: Command, *, should_respond: bool)
A container for data that is sent as a response to an CommandLoopMessage from the web app's
javascript
Attributes
topic: str
A category of data being sent, its purpose is similar to a MQTT topic
payload: Any
The raw data to be sent for processing
id: int
The ID number for this particular message, used for matching an CommandLoopMessage to the
correct CommandLoopResponse
event: threading.Event
Blocks until a response is received from the web app's javascript
result: Optional[Any]
Data received as a result of the web app processing this object's payload
should_respond: bool
If the web app should send data back in response to the Command contained in this response
Parameters
command: Command
The Command to convert into an CommandLoopResponse
should_respond: bool
If the web app should send data back in response to the Command contained in this response
Static methods
def nothing( )
The default CommandLoopResponse, used for a generic response
Methods
def to_json(self)->Dict[str, Any]
Converts the structured data in this object to a JSON-serializable Python® dictionary
This data is then sent to the web app's javascript as a response to a POST request
Returns
Dict[str, Any]
The JSON representation of this object, ready for sending to the web app's javascript
class EdgeInterface (import_name: str, disable_request_logging: bool=True)
An interface that manages and runs the web app
This interface handles both the creation of pages and running the development web server
Attributes
app: Flask
The actual web app
pages: Dict[Page]
A mapping of pages to their respective subdirectory, used for quickly gaining access to the page
object for page manipulation
server: threading.Thread
A background thread that handles serving the web app
Parameters
import_name: str
See Flask API documentation
disable_request_logging: bool, default=True
Disable the request logging or not, as it can become a lot due to the constant requests from the
command loop
Instance variables
var running: bool
If the server is currently running
Returns
bool
See above
Methods
def add_page(self, subdirectory: str, template: str, **template_kwargs)
Add a page to the web app
To access an added page, use the pages attribute of this object
A page with the subdirectory ‘/’ is required for the web app to run
Parameters
subdirectory: str
The subdirectory of the page to be added
Example: https://link.com/page<-/page is the subdirectory
template: str
The path to the HTML template file to be displayed on the page
** template_kwargs
Variables to pass into the template to be processed by Jinja
def set_global_update_interval(self, interval: int)
Sets how often (in milliseconds) the command loop should check for a new command for all pages
Parameters
interval: int
How often the page should check for a new command in milliseconds
def start_server(self, host: Optional[str]=None, port: Optional[int]=None)
Start serving the web app
def wait_forever(self)
Blocks infinitely, allowing the server to continue running
class MissingMainPage (*args, **kwargs)
Raised when the main page (“/”) of the application does not exist
Ancestors
builtins.Exception, builtins.BaseException
class Page (template: str, **template_kwargs)
An object representing one page of the web app
Attributes
template: str
The path to the HTML template file to be displayed on the page
template_kwargs: Dict[str, str]
Variables to pass into the template to be processed by Jinja
on_load: Callable[[ ], None]
A function that will be called whenever the page loads or reloads
_postman: Postman
A class that manages the sending and receiving of messages and their corresponding responses callbacks: Dict[str, Callable[[ ], None]]
Contains a mapping of an id to a callback to run when a web element with that id is clicked or
triggered
Parameters
template: str
The path to the HTML template file to be displayed on the page
**template_kwargs
Variables to pass into the template to be processed by Jinja
Instance variables
var active_session_data: dict
Returns the current session's data attribute, which is meant to allow developers to create and
modify data specific to the current session
Returns
dict
See above
var dashboard_mode: bool
If an action performed in one session should affect the information displayed on all active sessions
Returns
bool
See above
Methods
def console_log(self, text: str)
Logs text to the web app's console
Parameters
text: str
The text to log to the console
def evaluate_javascript(self, js: str, *, get_output: bool)->Optional [str]
Evaluates a string of javascript in the web app and returns its result if get_output is True
Parameters
js: str
The javascript to execute
get_output: bool
Whether to wait for and return the output of executing the javascript
def get_input_data(self, tag_id: str)->str
Returns the data contained in an <input> tag in the web app
Parameters
tag_id: str
The id of the <input> tag to get data from
Example: <input type=“text”id=“sample_id”>
Returns
str
The data received from the <input> tag
def on_button_click(self, tag_id: str, callback: Callable[[ ], None])
Registers a callback with a button's id to be called whenever the associated button is clicked
Parameters
tag_id: str
The id of the <input type=“button”> to listen for
callback: Callable[[ ], None]
The callback to call when the button is clicked
def on_request (self)->Union [Dict [str, Any], str]
Called when the page receives an HTTP request
A GET request will return the HTML of the page based on its template attribute
A POST request signifies a command loop action, either a request for a new message or a response
to a previous message
This method SHOULD NOT be overridden
Returns
Dict[str, Any]
This is returned if the page receives a POST request; a Python® dict that will be converted into a
JSON object by the web app's javascript
str
This is returned if the page receives a GET request; the raw HTML of the page
def set_button_text(self, tag_id: str, text: str)
Sets a button's value attribute to text
Parameters
tag_id: str
The id of the button to edit
Example: <input type=“button”id=“sample_id”>
text: str
The text to display in the button
def set_image_base64(self, tag_id: str, base64_str: str, filetype: str=‘jpg’)
Sets an image to a base64-encoded string
Parameters
tag_id: str
The id of the <img> tag to edit
Example: <img src=“#”id=“sample_id”/>
base64_str: str
The base64-encoded string to set the image to
filetype: str, default=‘jpg’
What filetype the base64-encoded string was encoded from
def set_image_src(self, tag_id: str, src: str)
Sets the src attribute of an image tag
Parameters
tag_id: str
The id of the <img> tag to edit
Example: <img src=“#”id=“sample_id”/>
src: str
The string to set the src attribute to
def set_text(self, tag_id: str, text: str)
Sets the innerHTML attribute of any tag in the web app
Parameters
tag_id: str
The id of the tag to edit
Example: <p id=“sample_id”></p>
text: str
The text to display in the tag
def set_update_interval(self, interval: int)
Setter function to tell the web app how often to update in milliseconds
Parameters
interval: int
How often the current page should be updated, in milliseconds
class PageAlreadyExists (*args, **kwargs)
Raised when a requested new subdirectory already exists
Ancestors
builtins.Exception, builtins.BaseException
class Postman
A class that manages the sending and receiving of messages and their corresponding responses
Attributes
_sessions: Dict[int, Session]
A dictionary that contains Session objects mapped to session ids. These Session objects contain
various attributes pertaining to how the session currently operates (see Session)
_thread_to_session: Dict[int, int]
A dictionary that maps a thread id to the session id it is currently operating on. This enables the
property active_session to work
in_waiting: Dict[int, CommandLoopResponse]
Maps the message's id and the actual message so that a response can be easily matched to its
corresponding message
dashboard_mode: bool
If an action performed in one session should affect the information displayed on all active sessions
Instance variables
var active_session: Optional[Session]
The current active Session object, identified by the current thread that is requesting this property.
If a thread that is accessing this property is not mapped to an existing session, a value of None is
returned, which tells the Postman that any data transmission should be performed on all active
sessions
Methods
def get_new_packet(self)->Dict [str, Any]
Returns the next packet in the queue ready for sending or an empty packet if there is none
Returns
Dict[str, Any]
The next packet in the queue ready for sending or an empty packet if there is none
def init_session(self)->Dict[str, Any]
Handles all the initialization involved in handling a brand-new session
Returns
Dict[str, Any]
A CommandLoopResponse object containing the “set_session_id” Command that has been
JSON serialized; ready to be used as a POST response
def invalidate_outgoing_packets(self)
Clears the outgoing packet queue so no old messages are sent to the web app's javascript
def process_message(self, message: CommandLoopMessage)
Matches an incoming CommandLoopMessage from the web app's javascript to its corresponding
CommandLoopResponse and then sets the response's event
Parameters
message: CommandLoopMessage
A message received from the web app's javascript containing the result of a subsequent
Command
def register_thread(self, session_id: int)
A method that stores the current thread id into the _thread_to_session dictionary.
In doing so, we enable the active_session property to return the current session
Parameters
session_id: int
The session id that the current thread should be mapped to
def send(self, command: Command)
Sends an CommandLoopResponse to the web app's javascript but does not wait for a response
Parameters
command: Command
The Command to be converted into an CommandLoopResponse and then processed by the web
app's javascript
def send_and_receive(self, command: Command)-> Any
Sends an CommandLoopResponse to the web app's javascript and then waits for and returns the
resulting data
Parameters
command: Command
The Command to be converted into an CommandLoopResponse and then processed by the web
app's javascript
Returns
Any
The data received as a result of the web app's javascript processing the Command
def unregister_thread(self)
Performs the opposite of register_thread and deletes the key-value pair containing the current
thread id in the _thread_to_session dictionary.
class Session (id: int, has_loaded: bool=False, data: dict=<factory>,
packet_queue: queue.Queue=<factory>)
An object that contains attributes specific to a single session
Attributes
id: int
The session id; this is a unique value that is assigned to a new session by a page's Postman. This is
how certain packets know to go to the correct session
has_loaded: bool, default=False
A boolean that indicates whether the session has loaded yet
data: dict
An empty Python® dictionary that allows for the storage of variables that belong to just a single
session. edge-interface does not interact with this dictionary and is solely intended to be used by the
developer for convenience in managing multiple sessions
packet_queue: queue.Queue
The Queue object that contains all the packets waiting to be sent to the web app's javascript
Class variables
var data: dict
var has_loaded: bool
var id: int
var packet_queue: queue.Queue
Index
Functions
debug_print
Classes
Command
javascript
payload
set_session_id
topic
update_interval
CommandLoopMessage
CommandLoopResponse
nothing
to_json
EdgeInterface
add_page
running
set_global_update_interval
start_server
wait_forever
MissingMainPage
Page
active_session_data
console_log
dashboard_mode
evaluate_javascript
get_input_data
on_button_click
on_request
set_button_text
set_image_base64
set_image_src
set_text
set_update_interval
PageAlreadyExists
Postman
active_session
get_new_packet
init_session
invalidate_outgoing_packets
process_message
register_thread
send
send_and_receive
unregister_thread
Session
data
has_loaded
id
packet_queue
Generated by pdoc 0.10.0.
and pressure are defined as 20° C. and 1 atmosphere.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A framework for attaching web interfaces to existing applications comprising:
at least one web interface;
at least one existing application;
at least one framework containing at least one source code for managing the at least one web interface, wherein the at least one source code is structured to work with multiple web interfaces; and
the at least one framework configured wherein at least one data transmitted bidirectionally between at least one Python® script and at least one webpage to enable at least one webpage element to interact with at least one portion of the at least one Python® script.

2. The framework for attaching web interfaces to existing applications of claim 1, wherein no rewriting of at least one logic is required for the at least one web interface to incorporate the framework with the at least one existing application.

3. The framework for attaching web interfaces to existing applications of claim 1, wherein no manual integration of the at least one framework into the existing application is required.

4. The framework for attaching web interfaces to existing applications of claim 1, wherein transmission of the at least one data transmitted bidirectionally between at least one Python® script and at least one webpage runs continuously via sending at least one series of sequential GET and POST requests.

5. The framework for attaching web interfaces to existing applications of claim 4, wherein the sequential GET and POST requests each have their own topic, identifier, flag, and payload to create a bi-directional data flow between the at least one framework and the at least one webpage.

6. The framework for attaching web interfaces to existing applications of claim 5, wherein the at least one Python® script cannot only send data during an initialization of the at least one webpage or when the at least one web interface initiates a data stream first but the at least one Python® script sends data upon request at any time by the at least one webpage to create a command loop.

7. A method for creating a framework for attaching web interfaces to existing applications comprising:
at least one webpage initiates at least one POST request to at least one webpage;
at least one interface defines at least one interface Postman object that manages transmission and reception of the at least one POST request and records a session id contained within the at least one POST request;
the at least one interface Postman object uses the session id to select at least one session object from at least one session store, wherein the at least one session store corresponds to the at least one session id; and
the at least one interface Postman object will respond with at least one JSON representation of at least one command object in a queue of the session object selected.

8. The method for creating a framework for attaching web interfaces to existing applications of claim 7, wherein the at least one JSON representation contains a task for the at least one webpage to complete as at least one payload.

9. The method for creating a framework for attaching web interfaces to existing applications of claim 8, wherein the at least one payload is executed in the at least one webpage's Javascript code.

10. The method for creating a framework for attaching web interfaces to existing applications of claim 9, wherein the at least one webpage's Javascript code sends a follow-up POST request, wherein the follow-up POST request has at least one identifier matching the at least one POST request and contains data representing at least one output of at least one completed task.

11. The method for creating a framework for attaching web interfaces to existing applications of claim 10, wherein a process of claim 11 is repeated to form at least one command loop.

12. The method for creating a framework for attaching web interfaces to existing applications of claim 7, further comprising forming a thread-safe queuing system wherein at least one packet is sent and received at any time from either the at least one interface or from at least one Python® script.

13. The method for creating a framework for attaching web interfaces to existing applications of claim 7, further comprising wherein multiple open sessions of the at least interface are open, the at least one interface dispatches a correct command to a correct session via recording a current thread identifier inside the session store and matching the current thread identifier with the session from which a most recent POST request originated.

14. The method for creating a framework for attaching web interfaces to existing applications of claim 12, further comprising a rate at which the at least one packet is sent or received is modifiable via an update-interval variable.

15. The method for creating a framework for attaching web interfaces to existing applications of claim 7. further comprising wherein the at least one web interface operates asynchronously in a background thread while public methods are synchronous, allowing the at least one interface to run in a foreground without interruptions.
